(19) United States
(12) Patent Application Publication
(10) Pub. No.: US 2011/0123168 A1
(43) Pub. Date: May 26, 2011

(54) MULTIMEDIA APPLICATION SYSTEM AND METHOD USING METADATA FOR SENSORY DEVICE

(75) Inventors: Maeng Sub Cho, Daejeon (KR); Jin Seo Kim, Daejeon (KR); Bon Ki Koo, Daejeon (KR); Ji Hyung Lee, Daejeon (KR); Chang Woo Chu, Daejeon (KR); Ho Won Kim, Daejeon (KR); II Kyu Park, Daejeon (KR); Yoon-Seok Choi, Daejeon (KR); Ji Young Park, Daejeon (KR); Seong Jae Lim, Daejeon (KR); Bon Woo Hwang, Daejeon (KR); Jeung Chul Park, Daejeon (KR); Kap Kee Kim, Daejeon (KR); Sang-Kyun Kim, Gyeonggi-do (KR); Yong-Soo Joo, Seoul (KR)

(73) Assignee: Electronics and Telecommunications Research Institute, Daejeon (KR)

(21) Appl. No.: 13/054,408

(22) PCT Filed: Jun. 19, 2009
(86) PCT No.: PCT/KR2009/003010

§ 371 Date: Jan. 14, 2011

(30) Foreign Application Priority Data
Jul. 14, 2008 (KR) 10-2008-0068054
Dec. 11, 2008 (KR) 10-2008-0126032

(51) Int. Cl. H04N 5/775; H04N 5/765; H04N 9/80

(52) U.S. Cl. 386/230; 386/200; 386/262; 386/E05.07; 386/E05.002

(57) ABSTRACT

A multimedia application system uses metadata for sensory devices. The system includes: a sensory-device engine for generating a sensory device command (SDC) for controlling the sensory devices based on sensory effect information (SEI) generated to represent sensory effects by using the sensory devices depending on video contents, user preference information (UPI) of the sensory devices and device capability information (DCI) indicative of reproducing capability of the sensory devices; and a sensory-device controller for controlling sensory devices to perform sensory effect reproduction in response to the generated SDC.

### TECHNICAL FIELD

The present invention relates to a technology for representing video contents to users; and more particularly, to a multimedia application system and method using metadata for sensory devices that are suitable for providing consumer-oriented, high-quality multimedia service according to a producer's intention during sensory reproduction processes from video contents production to ultimate consumption.

### BACKGROUND ART

In general, video contents are provided to users by using a computing device or an optical disk player to reproducing the video contents. In this case, the video contents may be stored in an optical disk such as a compact disc (CD), digital versatile disc (DVD), or Blue-Ray disk, and a reproduced image signal may be displayed on a monitor connected to the computing device or a television connected to the optical disk player.

However, as video-content reproduction technology is developed, researches are underway into sensory devices for representing sensory effects such as fog, wind, temperature, scent, light, lighting, and chair motion depending on video contents, and signal processing systems for controlling the sensory devices in order to provide a more lifelike image to users during video reproduction. Several systems using the technology are commercially available.

The conventional sensory devices provide several effects depending video contents, but have been implemented only in limited spaces.

Further, sensory effects are reproduced through sensory devices according to video contents in viewing video contents. However, an association relationship between the video contents and the sensory devices may differ. Therefore, a sensory device associated with video contents and having capability of reproducing sensory effects depending on the video contents is required to reproduce the sensory effects set in the video contents by using consumer electronics and illuminant devices equipped in user's place.

Further, the sensory effect is just a tool for enabling users to watch more lifelike video contents, but is incapable of controlling color impression according to a producer's intention and ambient illuminant. In addition, users who reproduce video contents cannot control desired sensory effects in the video contents.

### DISCLOSURE OF INVENTION

### Technical Problem

In view of the above, the present invention provides a multimedia application system and method using metadata for sensory devices capable of effectively controlling sensory devices, such as color impression of a display device and ambient illuminant depending on video contents.

The present invention further provides a multimedia application system and method using metadata for sensory devices that uses a new metadata format for optimizing adjustment of color impression of the display device and the sensory devices according to an intention of a video-content producer and video contents, and that is capable of providing consumer-oriented, high-quality multimedia service according to the video producer's intention.

The present invention further provides a multimedia application system and method using metadata for sensory devices capable of providing consumer-oriented, high-quality multimedia service according to a producer intention during sensory re-production processes from video contents production to ultimate consumption, by including a method for utilizing SEI metadata for effectively controlling sensory devices, such as color impression of a display device and ambient illuminant, and including metadata-based contents utilization tools, in a process of forming metadata for an application system for controlling the sensory devices depending on video contents.

The present invention includes various information required to effectively control sensory devices as metadata and metadata-based contents utilization tools when forming metadata for a multimedia application system for controlling the sensory devices, such as color impression of a display device and ambient illuminant depending on video contents in the video contents reproducing. Accordingly, sensory functions such as color impression of original video according to a producer intention and the like can be applied for video color reproduction and a consumer (user) of the video contents can choose the desired sensory functions. That is, in accordance with the present invention, consumer-oriented high-quality multimedia service can be provided.

### Technical Solution

In accordance with an aspect of the present invention, there is provided a multimedia application system using metadata for sensory devices, the system including: a sensory-device engine for generating a sensory device command (SDC) for controlling the sensory devices based on sensory effect information (SEI) generated to represent sensory effects by using the sensory devices depending on video contents, user preference information (UPI) of the sensory devices and device capability information (DCI) indicative of reproducing capability of the sensory devices; and a sensory-device controller for controlling sensory devices to perform sensory effect reproduction in response to the generated SDC.

In accordance with another aspect of the present invention, there is provided a multimedia application method using metadata for sensory devices, the method including: receiving, by a sensory-device engine, sensory effect information (SEI), the SEI being used for sensory devices to represent sensory effects according to video contents; receiving user preference information (UPI) of the sensory devices; receiving device capability information (DCI) indicative of reproducing capability of the sensory devices; generating a sensory device command (SDC) to control the sensory devices based on the SEI, UPI and DCI; and transmitting the SDC to a sensory-device controller interworking with sensory devices for performing sensory effect reproduction.

### ADVANTAGEOUS EFFECTS

In accordance with the present invention, it is possible to effectively control ambient sensory devices, such as color impression of a display device and ambient illuminant according to video contents when the consumer watches in reproducing the video contents by using a new metadata format for optimally adjusting the color impression of the display device and the ambient sensory devices according to video contents. Therefore, provides consumer-oriented, high-quality multimedia service corresponding to an existing producer's intention can be provided.

### BRIEF DESCRIPTION OF DRAWINGS

The objects and features of the present invention will become apparent from the following description of preferred embodiments given in conjunction with the accompanying drawings, in which:

FIG. 1 is a block diagram illustrating a multimedia application system in accordance with the embodiment of the present invention;

FIG. 2 is a block diagram illustrating an SEI metadata generator in accordance with the embodiment of the present invention;

FIG. 3 is a block diagram illustrating elements of an SEI metadata in accordance with the embodiment of the present invention;

FIG. 4 is a diagram illustrating SEI metadata in a schema format in accordance with the embodiment of the present invention;

FIG. 5 is a block diagram illustrating elements of SEI base type metadata provided as a top basic type in a basic type system in a schema of the SEI metadata in accordance with the embodiment of the present invention;

FIG. 6 is a diagram illustrating SEI base type metadata in a schema format in accordance with the embodiment of the present invention;

FIG. 7 is a block diagram illustrating elements of Group of Effects metadata in accordance with the embodiment of the present invention;

FIG. 8 is a diagram illustrating Group of Effects metadata in a schema format in accordance with the embodiment of the present invention;

FIG. 9 is a block diagram illustrating elements of metadata describing information of a sensory device for reproducing a wind effect in order to represent one sensory effect information in accordance with the embodiment of the present invention;

FIG. 10 is a structure diagram illustrating Fan Type metadata in a schema format in accordance with the embodiment of the present invention;

FIG. 11 is a block diagram illustrating elements of original (reference) color parameter metadata in accordance with the embodiment of the present invention;

FIG. 12 is a structure diagram illustrating original color metadata presented in a schema format in accordance with the embodiment of the present invention;

FIG. 13 is a block diagram illustrating elements of a tone reproduction curve in accordance with the embodiment of the present invention;

FIG. 14 is a structure diagram illustrating a tone reproduction curve presented in a schema format in accordance with the embodiment of the present invention;

FIG. 15 is a block diagram illustrating elements of an image conversion matrix in accordance with the embodiment of the present invention;

FIG. 16 is a diagram illustrating an image conversion matrix presented in a schema format in accordance with the embodiment of the present invention;

FIG. 17 is a block diagram illustrating elements of illuminant light source metadata in accordance with the embodiment of the present invention;

FIG. 18 is a structure diagram illustrating an illuminant light source presented in a schema format in accordance with the embodiment of the present invention;

FIG. 19 is a structure diagram illustrating elements of input device color gamut metadata in accordance with the embodiment of the present invention;

FIG. 20 is a diagram illustrating input device color gamut metadata presented in a schema format in accordance with the embodiment of the present invention;

FIG. 21 is a block diagram illustrating an UPI metadata generator in accordance with the embodiment of the present invention;

FIG. 22 is a block diagram illustrating elements of UPI metadata in accordance with the embodiment of the present invention;

FIG. 23 is a diagram illustrating UPI metadata presented in a schema format in accordance with the embodiment of the present invention;

FIG. 24 is a diagram illustrating elements of sensory effect preference information metadata according to an exemplary embodiment of the present invention;

FIG. 25 is a diagram illustrating sensory effect preference information metadata presented in a schema format in accordance with the embodiment of the present invention;

FIG. 26 is a block diagram illustrating a DCI metadata generator in accordance with the embodiment of the present invention;

FIG. 27 is a block diagram illustrating elements of DCI metadata in accordance with the embodiment of the present invention;

FIG. 28 is a diagram illustrating DCI metadata in a schema format in accordance with the embodiment of the present invention;

FIG. 29 is a block diagram illustrating elements of device capability metadata in accordance with the embodiment of the present invention;

FIG. 30 is a diagram illustrating device capability metadata presented in a schema format in accordance with the embodiment of the present invention;

FIG. 31 is a block diagram illustrating an SDC metadata generator in accordance with the embodiment of the present invention;

FIG. 32 is a block diagram illustrating SDC elements of metadata in accordance with the embodiment of the present invention;

FIG. 33 is a structure diagram illustrating SDC metadata presented in a schema format in accordance with the embodiment of the present invention;

FIG. 34 illustrates an example of one sensory device command in accordance with the embodiment of the present invention, in which elements of metadata “Set Fan Type” describing control command information of a device for reproducing a wind effect are shown in a block diagram;

FIG. 35 is a structure diagram illustrating set metadata Fan Type presented in a schema format according to an exemplary embodiment of the present invention; and

FIG. 36 illustrates multimedia application service of reproducing a sensory effect by using metadata in reproducing advertisement video contents in accordance with the embodiment of the present invention.

### BEST MODE FOR CARRYING OUT THE INVENTION

Hereinafter, embodiments of the present invention will be described in detail with reference to the accompanying drawings.

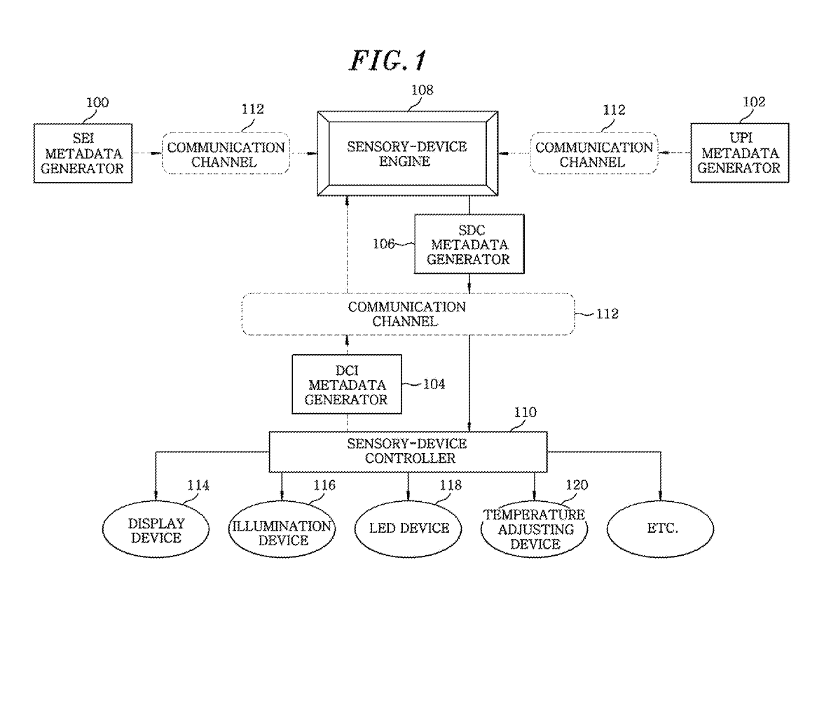

FIG. 1 is a block diagram illustrating a multimedia application system in accordance with an embodiment of the present invention.

Referring to FIG. 1, the multimedia application system includes a SEI metadata generator 100 for generating sensory effect information (SEI) metadata of video contents, a UPI metadata generator 102 for generating user preference information (UPI) metadata, a DCI metadata generator 104 for generating device capability information (DCI) metadata, a SDC metadata generator 106 for generating sensory device command (SDC) metadata, a sensory-device engine 108, a sensory-device controller 110, and a communication channel 112.

First, a method for driving a multimedia application system will be briefly described. Metadata are respectively generated by the SEI metadata generator 100 and the UPI metadata generator 102 and transferred to the sensory-device engine 108 through the communication channel 112 for interpreting and controlling sensory device-related metadata. The sensory-device engine 108 generates SDC metadata through the SDC metadata generator 106 and transfers the metadata to the sensory-device controller 110. The sensory-device controller 110 provides high-quality multimedia service through sensory devices controlled by the sensory-device controller 110 (e.g., at least one of a display device 114, an illuminant device 116, a light emitting diode (LED) device 118, and a temperature adjusting device 120), or through a sensory device (e.g., a wind adjusting device or a scent adjusting device) controlled according to video contents.

Here, the sensory-device engine 108 generates the SDC information for sensory device control, based on the SEI, UPI, and DCI metadata received from the respective metadata generators.

For example, the sensory-device engine 108 reflects the UPI to the SEI and recognizes information on an available sensory device based on the DCI to generate the SDC information. In this case, sensory devices controlled by the sensory-device controller 110 based on the received SEI, UPI, and DCI and a control range of the sensory devices are set in the generated SDC.

The SEI metadata generator 100 generates SEI metadata describing an effect of the sensory device designated by a video content producer, the UPI metadata generator 102 generates UPI metadata describing user preference information related to sensory effect reproduction preferred by an end user, and the DCI metadata generator 104 generates DCI metadata describing device capability information for the sensory device connected to the sensory-device controller 110.

That is, the sensory-device controller 110 generates device capability information in which a control range is set to control sensory devices connected to the sensory-device controller 110 by using the DCI metadata generator 104.

The sensory-device engine 108 receives the SEI, UPI and DCI metadata, and transfers information for controlling the sensory devices(i.e., SDC information) made based on the received metadata to SDC metadata generator 106. The sensory-device controller 106 generates SDC metadata describing the SDC information.

In this case, data transmission and reception between the metadata generators 100, 102 and 105 and the sensory-device engine 108 and data transmission and reception between the sensory-device engine 108 and the sensory-device controller 110 are performed via the communication channel 112. Here, the communication channel 112 connecting between the sensory-device engine 108 and the sensory-device controller 110 may be a wired network, such as an optical cable or a LAN (UTP: Unshielded Twisted Pair) cable to communicate data using specific communication protocol. CDMA, WCDMA, or FDMA, and wireless communication such as Blue Tooth, WIBRO, or a wireless local area network (LAN) system may be used for the data transmission and reception. Further, any other communication system may be applied if it can be used for data transmission and reception.

Meanwhile, in the present invention, the metadata is described according to a standardized format and structure using an MPEG-7 Multimedia Description Scheme (MDS) and an MPEG-21 digital item adaptation (DIA).

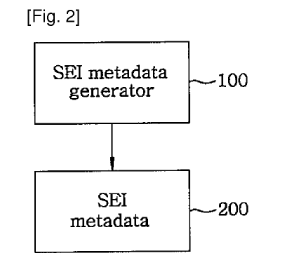

FIG. 2 is a block diagram illustrating the SEI metadata generator in accordance with the present embodiment.

Referring to FIG. 2, the SEI metadata generator 100 generates SEI metadata 200 describing an effect of the sensory device designated by video content producer.

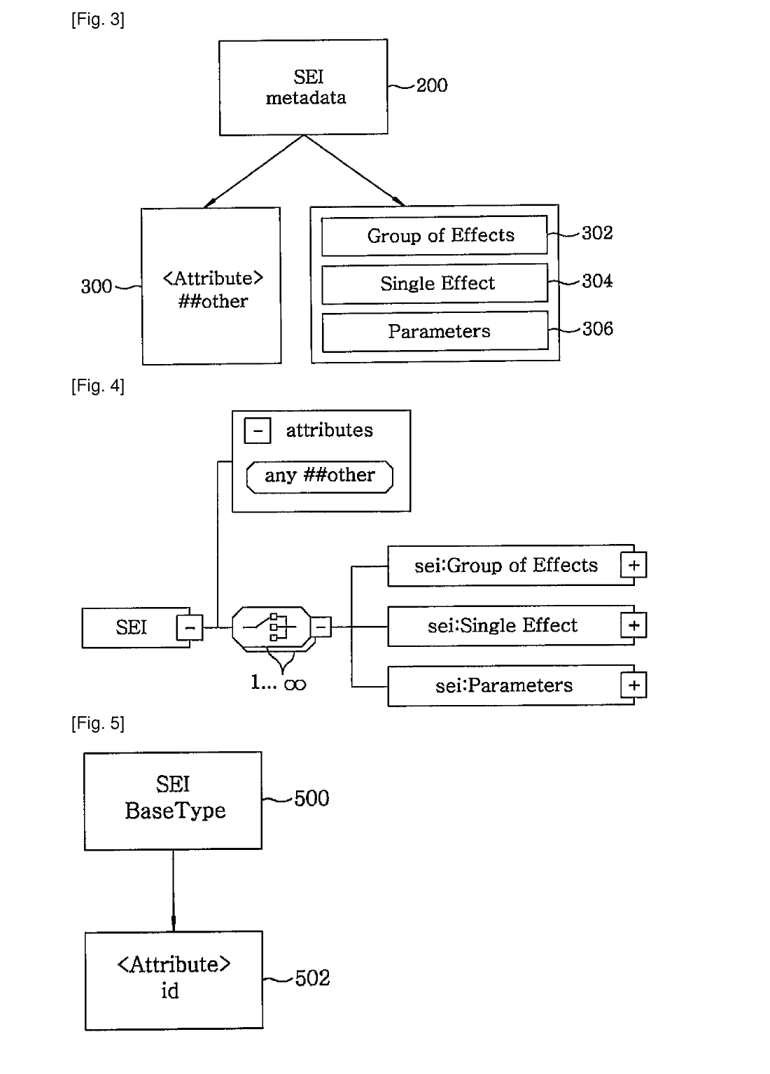

FIG. 3 is a block diagram illustrating elements of the SEI metadata in accordance with the present embodiment. Referring to FIG. 3, the SEI metadata 200 includes metadata “##other” 300 describing attribute information of an extensible sensory device, and metadata “Group of Effects” describing two or more sensory effect information 302, metadata “Single Effect” 304 describing one sensory effect information, and metadata “Parameters” 306 describing parameters related to the sensory effects. The video content producer produces various sensory effect information for the sensory device.

FIG. 4 shows SEI metadata described in a schema format in accordance with the present embodiment. The SEI metadata 200 in FIG. 3 and elements of the SEI metadata 200 are described in a schema format.

Table 1 shows a description of the SEI metadata 200 in an extensible markup language (XML) schema format.

TABLE 1

<element name=“SEI”> <complexType> <choice
maxOccurs=“unbounded”> <element name=“GroupOfEffects”
type=“sei:GroupOfEffectsType”/> <element name=“SingleEffect”
type=“sei:SingleEffectBaseType”/> <element name=“Parameters”
type=“sei:ParametersBaseType”/> </choice> <anyAttribute
namespace=“##other” processContents=“lax”/>
</complexType></element>

FIG. 5 is a block diagram illustrating elements of SEI base type metadata provided as a top basic type in a basic type system in a schema of the SEI metadata 200 in accordance with the present embodiment. Referring to FIG. 5, SEI base type metadata 500 includes metadata id 502 describing identifiable attribute information.

In FIG. 5, the SEI base type metadata 500 is used for basic types of single effect metadata 304 (Single Effect Base Type), a basic type of parameter metadata 306 (Parameters Base Type), and a basic type of SDC metadata SDC Base Type as shown in FIG. 3.

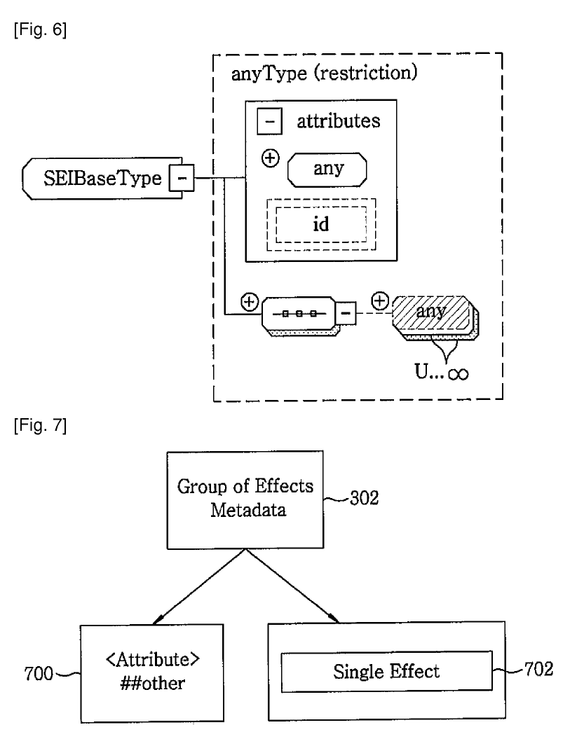

FIG. 6 shows SEI base type metadata described in a schema format in accordance with the present embodiment. The SEI base type metadata 500 shown in FIG. 5 and elements of the SEI base type metadata 500 are described in the schema format.

Table 2 shows a description of the SEI base type metadata 500 in an XML schema format.

TABLE 2

<complexType name=“SEIBaseType” abstract=“true”>
<complexContent> <restriction base=“anyType”> <attribute
name=“id” type=“ID” use=“optional”/> </restriction>
</complexContent></complexType>

FIG. 7 is a block diagram illustrating elements of Group of Effects metadata in accordance with the present embodiment. Referring to FIG. 7, the Group of Effects metadata 302 includes at least two of metadata ##other 700 describing attribute information for an extensible sensory device, and metadata Single Effect 702 describing one sensory effect information.

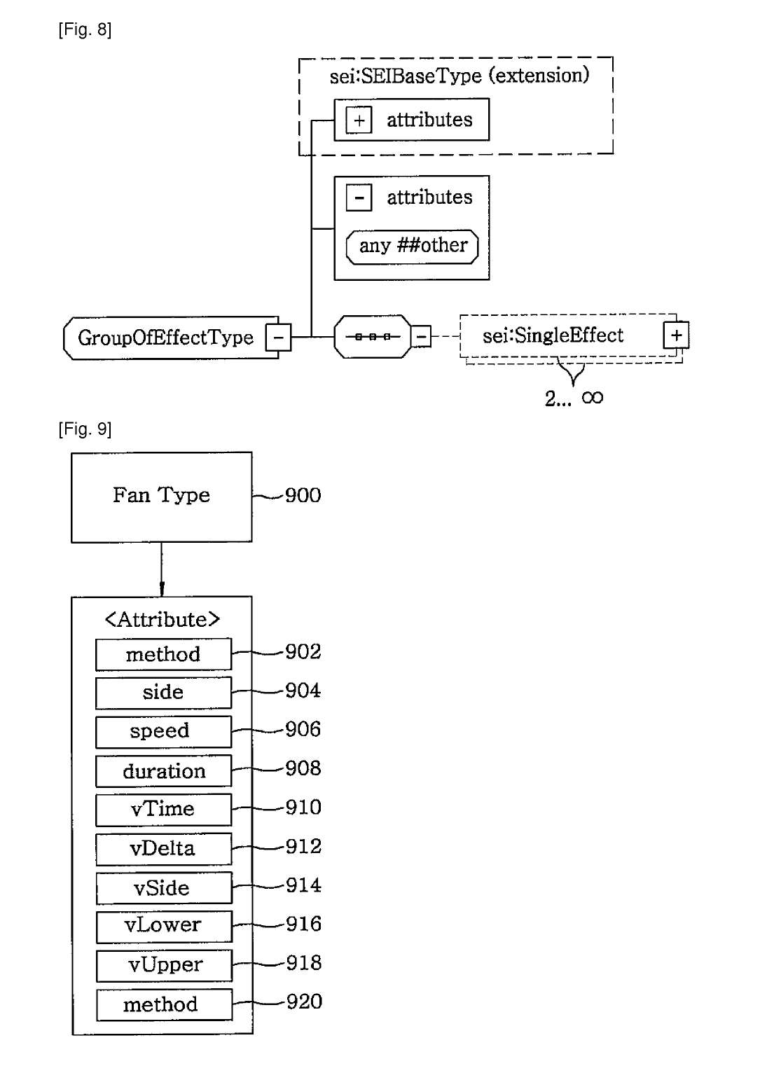

FIG. 8 shows Group of Effects metadata described in a schema format in accordance with the present embodiment, in which the Group of Effects metadata 302 in FIG. 7 and elements of the Group of Effects metadata 302 are described in the schema format.

Table 3 shows a description of Group of Effects metadata 302 in an XML schema format.

TABLE 3

<complexType name=“GroupOfEffectsType”> <complexContent>
<extension base=“sei:SEIBaseType”> <sequence> <element
name=“SingleEffect” type=“sei:SingleEffectBaseType”
minOccurs=“2” maxOccurs=“unbounded”/> </sequence>
<anyAttribute namespace=“##other” processContents=“lax”/>
</extension> </complexContent></complexType>

Table 4 shows a description provided as a basic type of single effect metadata 304, which is described in an XML schema format.

TABLE 4
<complexType name=“SingleEffectBaseType” abstract=“true”>
<complexContent> <extension base=“sei:SEIBaseType”> <anyAttribute
namespace=“##other” process- Contents=“lax”/> </extension>
</complexContent></complexType>

Table 5 shows a description provided as a basic type of parameter metadata 306, which is described in an XML schema format.

TABLE 5
<complexType name=“ParametersBaseType” abstract=“true”>
<complexContent> <extension base=“sei:SEIBaseType”> <anyAttribute
namespace=“##other” process- Contents=“lax”/> </extension>
</complexContent></complexType>

FIG. 9 is a block diagram illustrating elements of metadata Fan Type 900 describing information of a device for reproducing a wind effect in order to present one sensory effect information according to the present embodiment.

Referring to FIG. 9, the elements includes metadata method 902 describing attribute information of a reproduction method of a device, metadata side 904 describing attribute information indicating position information, metadata “speed 906 describing attribute information indicating reproduction intensity, metadata duration 908 describing attribute information indicating a duration in which video contents are uniformly reproduced, metadata vTime 910 describing attribute information indicating a duration in which video contents are variably reproduced, metadata vDelta 912 describing attribute information indicating a time change during a varying duration, metadata vSide 914 describing attribute information indicating a varying pattern, metadata vLower 916 describing attribute information indicating a lowest value of varying reproduction intensity, metadata vUpper 918 describing attribute information indicating a highest value of the varying reproduction intensity, and metadata activate” 920 describing attribute information of activation of a sensory device.

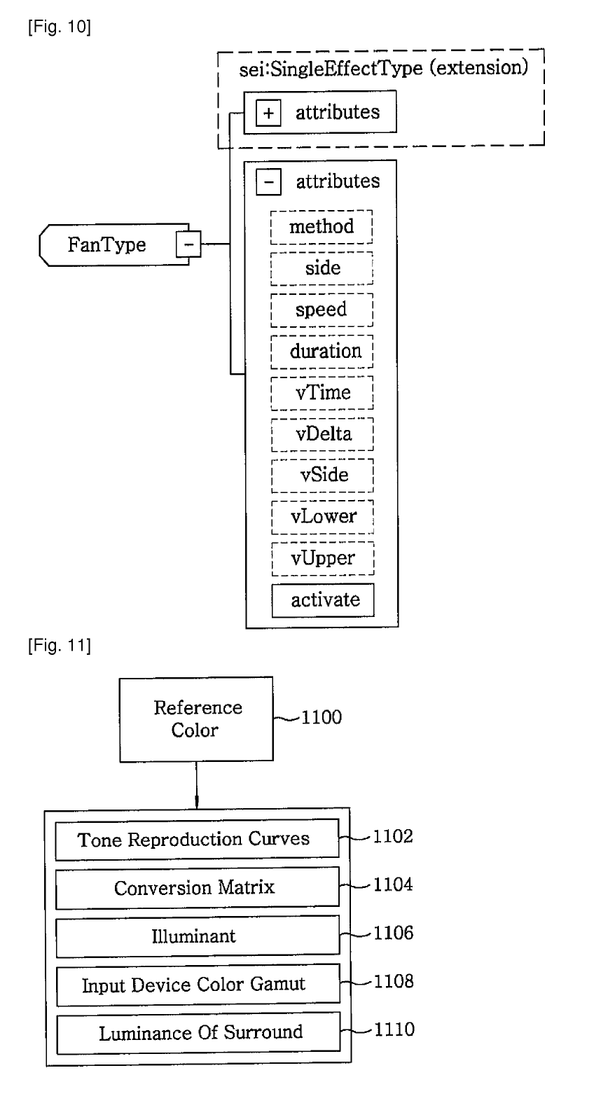

FIG. 10 is shows Fan Type metadata 900 described in a schema format in accordance with the present embodiment, in which the metadata Fan Type 900 and elements of the metadata Fan Type 900 are represented in a schema format.

Table 6 shows a description provided as a basic type of the metadata Fan Type 900, which is described in an XML schema format.

TABLE 6
<complexType name=“FanType”> <complexContent> <extension
base=“sei:SingleEffectBaseType”> <attribute name=“method”
type=“sei:unsignedPatternType” use=“optional”/> <attribute
name=“side” type=“sei:unsignedPatternType” use=“optional”/>
<attribute name=“speed” type=“sei:percentType” use=“optional”/>
<attribute name=“duration” type=“double” use=“optional”/>
<attribute name=“vTime” type=“double” use=“optional”/> <attribute
name=“vDelta” type=“double” use=“optional”/> <attribute name=“vSide”
type=“sei:unsignedPatternType” use=“optional”/> <attribute
name=“vLower” type=“sei:percentType” use=“optional”/> <attribute
name=“vUpper” type=“sei:percentType” use=“optional”/> <attribute
name=“activate” type=“sei:unsignedPatternType” use=“required”/>
</extension> </complexContent></complexType>

Further, in the present invention, various sensory effect information such as temperature, illuminant, vibration and the like may be represented by using a method for generating metadata obtained by extending the description of the single effect metadata 304 as the metadata Fan Type 900 that is one embodiment for presenting one sensory effect information.

FIG. 11 is a block diagram illustrating elements of original (reference) color parameter metadata according to an exemplary embodiment of the present invention.

Referring to FIG. 11, metadata reference color parameter 1100 describing original-color restoration information of video contents includes tone reproduction curves 1102 describing curves showing a property of an original color display device for successful color restoration, a conversion matrix 1104 describing a matrix performing image conversion from a color space of an original image to a standard color space, an illuminant 1106 describing a type of an illuminant light source in an original image task space, an input device color gamut 1108 describing a color gamut of an original color display, and luminance of surround 1110 describing ambient luminance.

In the present invention, although a gain offset gamma (GOG) model is used as a color space conversion method, it may use other conversion models, such as polynomial conversion or PLCC.

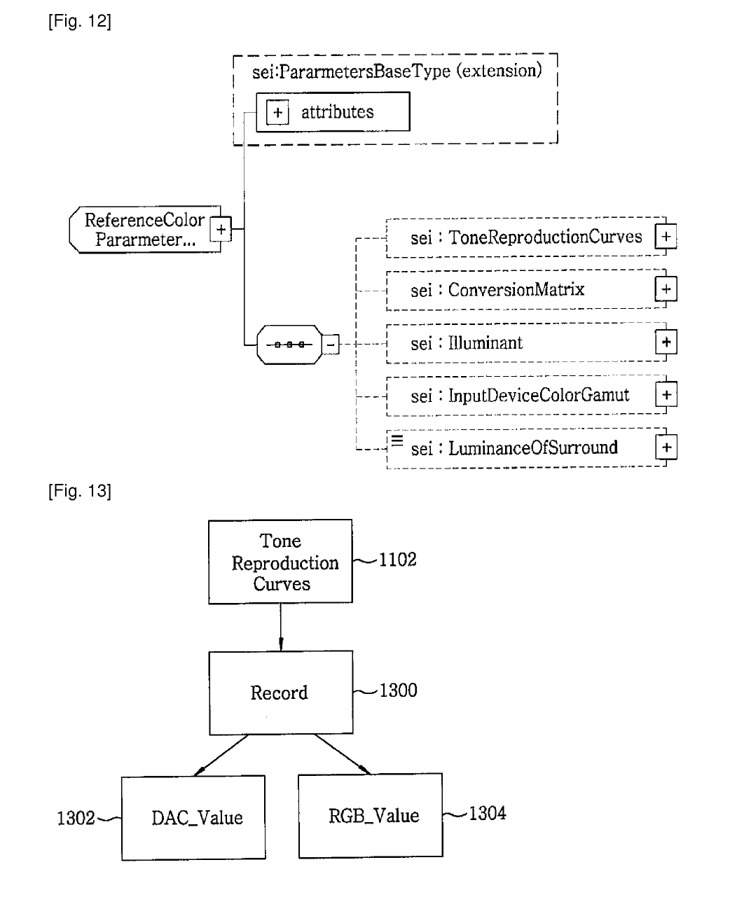

FIG. 12 is a diagram illustrating original color metadata described in a schema format in accordance with the present embodiment, in which reference color parameter metadata 1100 and elements of the reference color parameter metadata 1100 are represented in a schema format.

Table 7 shows a description of the reference color parameter metadata 1100, which is described in an XML schema format.

TABLE 7
<complexType name=“ReferenceColorParameterType”>
<complexContent> <extension base=“sei:ParametersBaseType”>
<sequence> <element name=“ToneReproductionCurves”
type=“sei:ToneReproductionCurvesType” minOccurs=“0”/>
<element name=“ConversionMatrix”
type=“sei:ConversionMatrixType”/> <element
name=“Illuminant” type=“sei:IlluminantType”
minOccurs=“0”/> <element name=“InputDeviceColorGamut”
type=“sei:InputDeviceColorGamutType” minOccurs=“0”/>
<element name=“LuminanceOfSurround”
type=“sei:LuminanceType” minOccurs=“0”/> </sequence>
</extension> </complexContent> </complexType>
<complexType name=“ToneReproductionCurvesType”> <sequence>
<element name=“Record” maxOccurs=“256”> <complexType>
<sequence> <element name=“DAC_Value” type=“mpeg7:unsigned8”/>
<element name=“RGB_Value” type=“mpeg7:doubleVector”/>
</sequence> </complexType> </element> </sequence>
</complexType> <complexType name=“ConversionMatrixType”>
<sequence> <element name=“RGB_XYZ”
type=“mpeg7:DoubleMatrixType”/> <element name=“RGBScalar_Max”
type=“mpeg7:doubleVector”/> <element name=“Offset_Value”
type=“mpeg7:doubleVector”/> <element name=“Gain_Offset_Gamma”
type=“mpeg7:DoubleMatrixType”/> <element name=“Inversematrix”
type=“mpeg7:DoubleMatrixType”/> </sequence> </complexType>
<complexType name=“IlluminantType”> <sequence> <element
name=“Daylight” type=“string”/> <element name=“XY_Value”
type=“dia:ChromaticityType”/> </sequence> </complexType>
<complexType name=“InputDeviceColorGamutType”> <sequence>
<element name=“IDCG_Type” type=“string”/> <element
name=“IDCG_Value” type=“mpeg7:DoubleMatrixType”/> </sequence>
</complexType> <simpleType name=“LuminanceType”> <restriction
base=“mpeg7:unsigned12”/> </simpleType>

FIG. 13 is a block diagram illustrating elements of a tone reproduction curve in accordance with the present embodiment.

Referring to FIG. 13, elements of metadata tone reproduction curves 1102 describing curves showing a property of an original color display device are shown. The metadata tone reproduction curves 1102 includes Record 1300 metadata describing a digital to analog conversion (DAC) value and an RGB value required for representing a gamma data for each channel of the original color display device, DAC_Value 1302 metadata describing the DAC value, and RGB_Value 1304 metadata describing the RGB value of each channel.

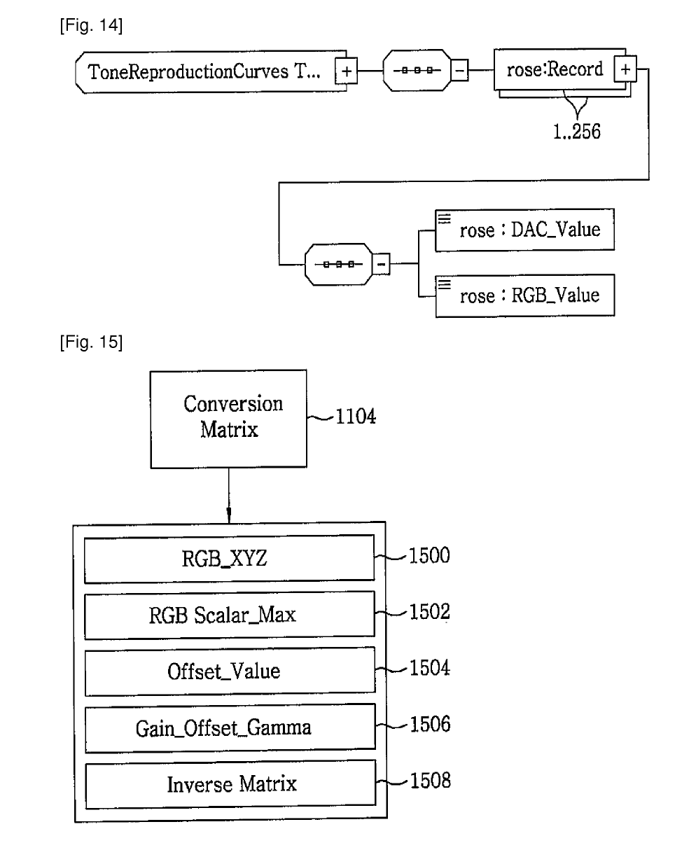

FIG. 14 is a diagram illustrating a tone reproduction curve described in a schema format in accordance with the present embodiment, in which the metadata tone reproduction curves 1102 and elements of the metadata tone reproduction curves 1102 are represented in a schema format.

Table 8 shows an example of metadata tone reproduction curves 1102 in an XML instance format.

TABLE 8
<ToneReproductionCurves> <Record> <DAC_Value>0</DAC_Value>
<RGB_Value>0.0000 0.0000 0.0000</RGB_Value>
</Record></ToneReproductionCurves>

FIG. 15 is a block diagram illustrating elements of an image conversion matrix in accordance with the present embodiment.

Referring to FIG. 15, elements of metadata conversion matrix 1104 describing a matrix for performing image conversion from a color space of an original image to a standard color space are shown. The metadata conversion matrix 1104 includes RGB_XYZ 1500 describing a matrix for converting a RGB color space into an XYZ color space, RGBScalar_Max 1502 describing an RGB scalar maximum value of each channel required for GOG conversion, Offset_Value 1504 describing an offset value of the original color display device, Gain Offset_Gamma 1506 describing a gain, an offset, and a gamma value of the original color display device, which are parameters required for GOG conversion, and Inverse matrix 1508 describing a matrix for inverse-converting the XYZ color space into the RGB color space.

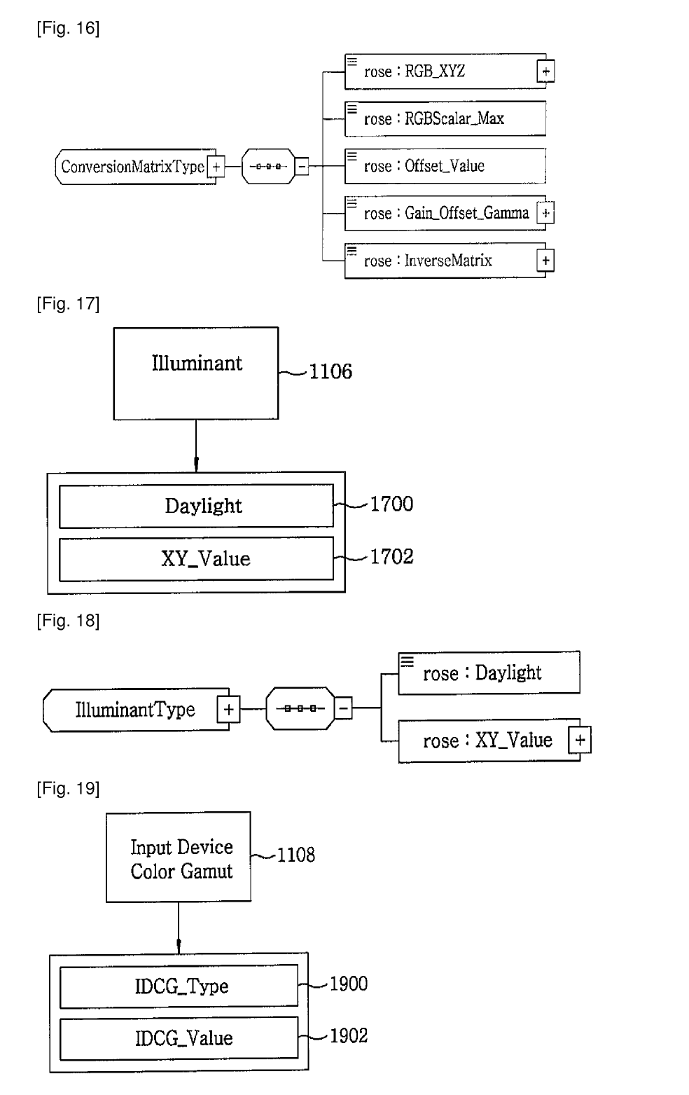

FIG. 16 is a diagram illustrating an image conversion matrix described in a schema format in accordance with the present embodiment, in which the conversion matrix metadata 1104 and elements of the conversion matrix metadata 1104 are represented in a schema format.

Table 9 shows an example of a conversion matrix metadata 1104 described in an XML instance format.

TABLE 9
<ConversionMatrix> <RGB_XYZ mpeg7:dim=“3 3”> .6000 67.6000
38.0000 .0000 137.0000 16.5000 .3650 19.4100 203.9000 </RGB_XYZ>
<RGBScalar_Max>0.9910 0.9860 0.9820</RGBScalar_Max>
<Offset_Value>0.2150 0.2050 0.4250</Offset_Value>
<Gain_Offset_Gamma mpeg7:dim=“3 3”> .0228 −0.0228 1.6222 .0242
−0.0242 1.5624 .0220 −0.0220 1.6180 </Gain_Offset_Gamma>
<Inversematrix mpeg7:dim=“3 3”> .0155 −0.0073 −0.0023 .0052
0.0099 0.0002 .0003 −0.0009 0.0049
</Inversematrix></ConversionMatrix>

FIG. 17 is a block diagram illustrating elements of illuminant light source metadata in accordance with the present embodiment.

Referring to FIG. 17, elements of metadata illuminant 1106 describing a type of an illuminant light source in an original image task space are shown. The metadata illuminant 1106 includes daylight 1700 describing a CIE standard illuminant type, and XY_Value 1702 metadata describing a white point chromaticity value according to standard illuminant type.

FIG. 18 is a diagram illustrating an illuminant light source described in a schema format in accordance with the present embodiment, in which the illuminant metadata 1106 and elements of the illuminant metadata 1106 are represented in a schema format.

Table 10 shows an example of the illuminant metadata 1106 described in an XML instance format.

TABLE 10

<Illuminant> <Daylight>D65</Daylight> <XY_Value x=“0.3127”
y=“0.3290”></XY_Value></Illuminant>

FIG. 19 is a diagram illustrating elements of input device color gamut metadata in accordance with the present embodiment.

Referring to FIG. 19, elements of metadata input device color gamut 1108 describing a color gamut of the original color display are shown. The metadata input device color gamut metadata 1108 includes IDCG_Type 1900 describing a type of an input device, and IDCG_Value 1902 metadata describing x, y values in a maximum DAC value of the input device.

FIG. 20 is a diagram illustrating input device color gamut metadata described in a schema format in accordance with the present embodiment, in which the metadata input device color gamut 1108 and elements of the metadata input device color gamut 1108 are represented in a schema format.

Table 11 shows an example of the input device color gamut metadata 1108 described in an XML instance format.

TABLE 11
<InputDeviceColorGamut> <IDCG_Type>NTSC</IDCG_Type>
<IDCG_Value mpeg7:dim=“2 3”> .6700 0.3300 .2100 0.7100 .1400
0.0800 </IDCG_Value></InputDeviceColorGamut>

FIG. 21 is a block diagram illustrating an UPI metadata generator in accordance with the present embodiment.

Referring to FIG. 21, a UPI metadata generator 102 generates UPI metadata 2100 including metadata information for user preference information.

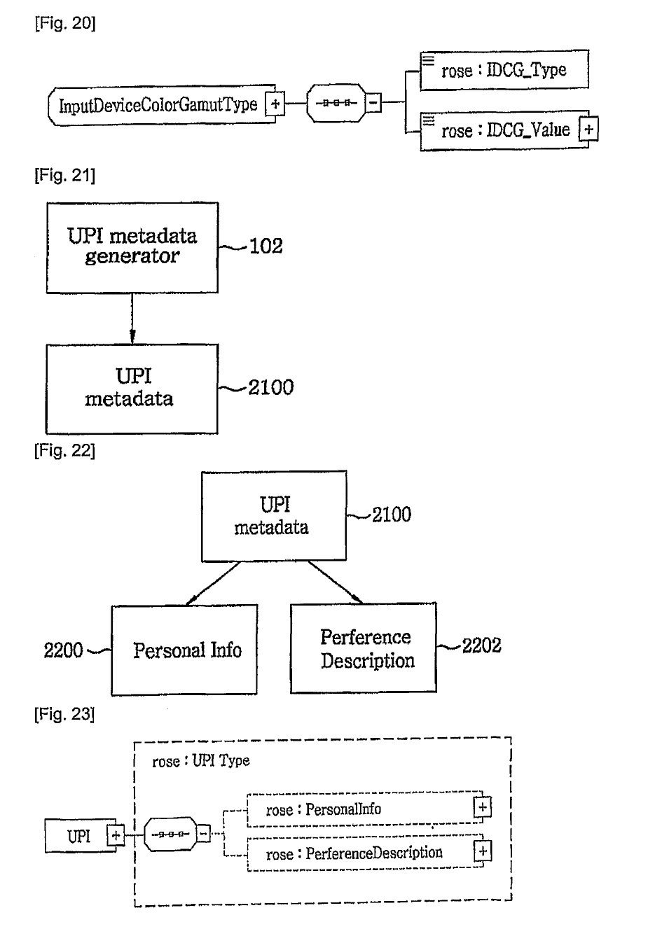

FIG. 22 is a block diagram illustrating elements of UPI metadata in accordance with the present embodiment.

Referring to FIG. 22, metadata UPI 2100 includes metadata Personal Info 2200 describing personal information of an end user, and metadata Preference Description 2202 describing sensory effect preference information.

FIG. 23 is a diagram illustrating UPI metadata described in a schema format in accordance with the present embodiment, in which the UPI metadata 2100 and elements of the UPI metadata 2100 are represented in a schema format.

Table 12 shows a description of the UPI metadata 2100 in an XML schema format.

TABLE 12

<element name=“UPI” type=“rose:UPIType”/> <complexType
name=“UPIType”> <sequence> <element name=“PersonalInfo”
type=“mpeg7:PersonType” minOccurs=“0”/> <element
name=“PreferenceDescription” type=“rose:PreferenceType”
minOccurs=“0”/> </sequence> </complexType>

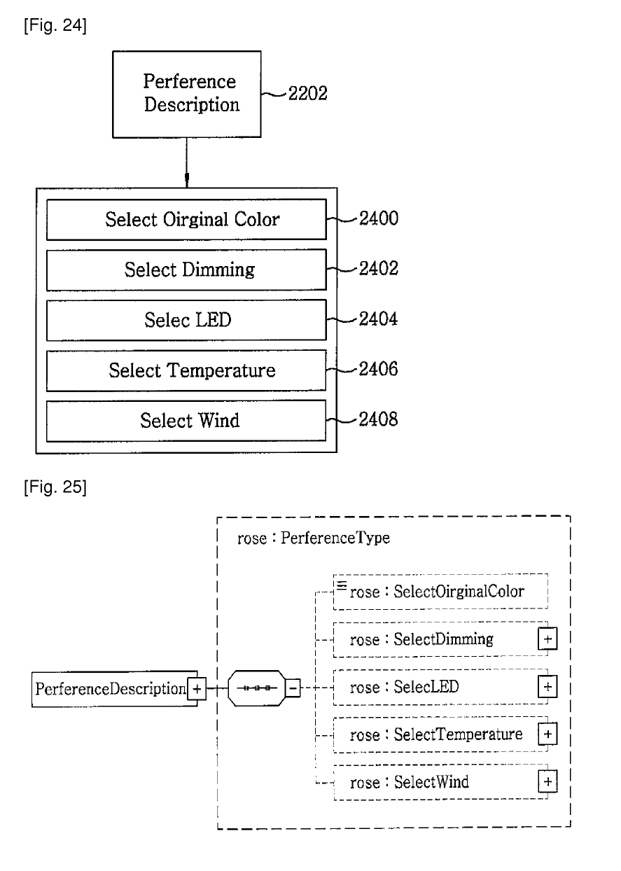

FIG. 24 is a diagram illustrating elements of sensory effect preference information metadata in accordance with the present embodiment.

Referring to FIG. 24, elements of metadata preference description 2202 describing sensory effect preference information are shown. The preference description metadata 2202 includes metadata Select Reference Color 2400 describing preference information of original-color restoration of video contents of a user, metadata Select Dimming 2402 describing illuminant adjustment preference information, metadata Select LED 2404 describing ambient illuminant adjustment preference information, metadata Select Temperature 2406 describing temperature adjustment preference information, and metadata Select Wind 2408 describing preference information for other reproducible effects.

FIG. 25 is a diagram illustrating sensory effect preference information metadata described in a schema format in accordance with the present embodiment, in which elements of the preference description metadata 2202 and the preference description metadata 2204 are represented in a schema format.

Table 13 shows a description of the preference description metadata 2204 in an XML schema format.

TABLE 13
<element name=“PreferenceDescription” type=“rose:PreferenceType”/>
<complexType name=“PreferenceType”> <sequence> <element
name=“SelectOriginalColor” type=“boolean” minOccurs=“0”/>
<element name=“SelectDimming” type=“rose:SelectType”
minOccurs=“0”/> <element name=“SelectLED” type=“rose:SelectType”
minOccurs=“0”/> <element name=“SelectTemperature”
type=“rose:SelectTemperatureType” minOccurs=“0”/> <element
name=“SelectWind” type=“rose:SelectType” minOccurs=“0”/>
</sequence> </complexType> <complexType name=“SelectType”>
<sequence> <element name=“Select” type=“boolean” minOccurs=“0”/>
<element name=“MaxLevel” type=“rose:LevelType” minOccurs=“0”/>
<element name=“MinLevel” type=“rose:LevelType” minOccurs=“0”/>
</sequence> </complexType> <complexType
name=“SelectTemperatureType”> <sequence> <element name=“Select”
type=“boolean” minOccurs=“0”/> <element name=“MaxTemperature”
type=“rose:MaxTemperatureType” minOccurs=“0”/> <element
name=“MinTemperature” type=“rose:MinTemperatureType”
minOccurs=“0”/> </sequence> </complexType> <simpleType
name=“LevelType”> restriction base=“unsignedInt”>
<minInclusive value=“0”/> <maxInclusive value=“100”/>
</restriction> </simpleType>

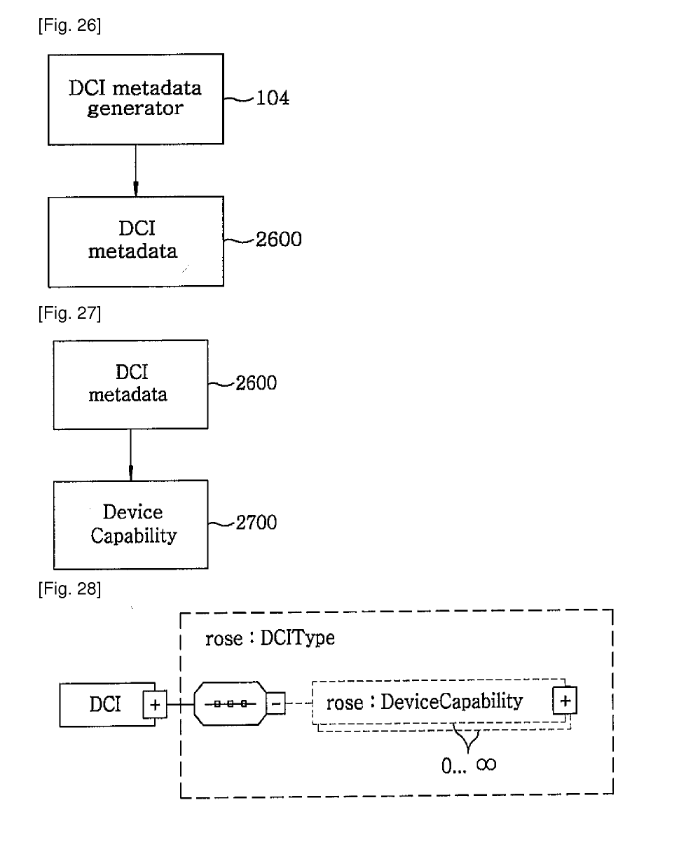

FIG. 26 is a block diagram illustrating the DCI metadata generator in accordance with an exemplary embodiment of the present invention.

Referring to FIG. 26, the DCI metadata generator 104 generates metadata DCI 2600 including metadata information for device capability information.

FIG. 27 is a block diagram illustrating elements of DCI metadata in accordance with the present embodiment, in which the DCI metadata 104 includes metadata “device capability” 2700 describing the device reproduction capability.

FIG. 28 is a diagram illustrating DCI metadata in a schema format in accordance with the present embodiment, in which the DCI metadata 104 and the device capability 2700 that is an element of the DCI metadata 104 is represented in a schema format.

Table 14 shows a description of DCI metadata 104 in an XML schema format.

TABLE 14
<element name=“DCI” type=“rose:DCIType”/> <complexType
name=“DCIType”> <sequence> <element name=“DeviceCapability”
type=“rose:DeviceCapabilityType” minOccurs=“0”
maxOccurs=“unbounded”/> </sequence> </complexType>

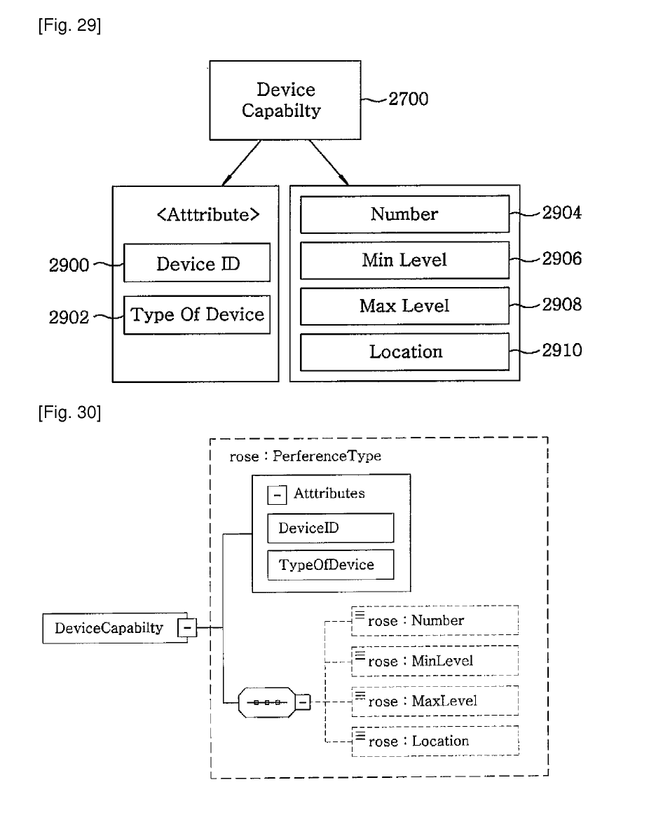

FIG. 29 is a block diagram illustrating elements of device capability metadata in accordance with the present embodiment.

Referring to FIG. 29, elements of the metadata device capability 2700 describing reproduction capability of the device are shown. In FIG. 29, the device capability metadata 2700 includes metadata Device ID 2900 describing unique identification number attribute information of the device, metadata Type Of Device 2902 describing attribute information indicating a device type, metadata Number 2904 describing number of sensory effect sensory devices, metadata Min Level 2906 describing minimum device capability information, metadata Max Level 2908 describing maximum device capability information, and metadata Location 2910 describing device position information.

FIG. 30 is a diagram illustrating device capability metadata described in a schema format in accordance with the present embodiment, in which device capability metadata 2700 is represented in a schema format.

Table 15 shows a description of device capability metadata 2700 in an XML schema format.

TABLE 15
<complexType name=“DeviceCapabilityType”> <sequence> <element
name=“Number” type=“rose:LevelType” minOccurs=“0”/> <element
name=“MinLevel” type=“rose:LevelType” minOccurs=“0”/> <element
name=“MaxLevel” type=“rose:LevelType” minOccurs=“0”/> <element
name=“Location” type=“rose:LevelType” minOccurs=“0”/>
</sequence> <attribute name=“DeviceID” type=“ID”
use=“required”/> <attribute name=“TypeOfDevice” use=“required”>
<simpleType> restriction base=“string”> <enumeration
value=“Dimming”/> <enumeration value=“LED”/> <enumeration
value=“Temperature”/> enumeration value=“Wind”/>
</restriction> </simpleType> </attribute></complexType>

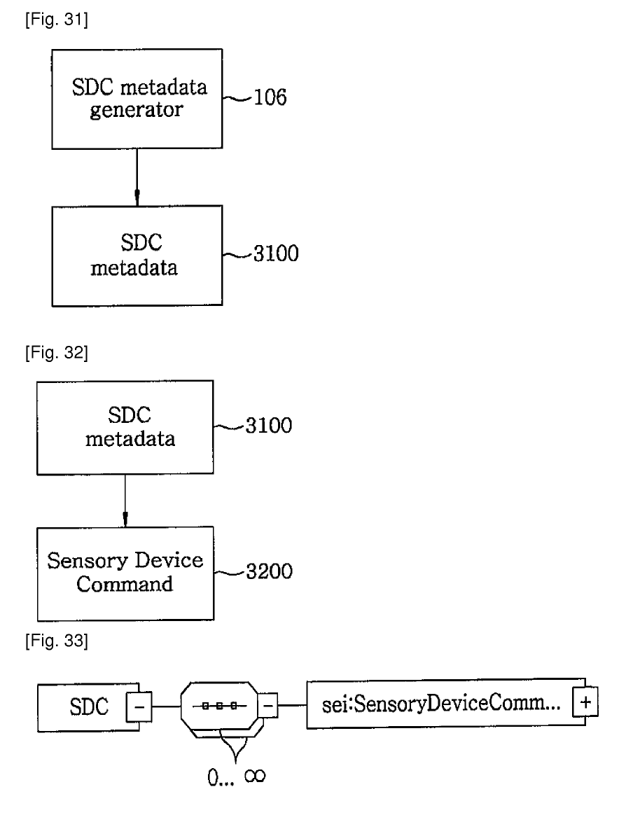

FIG. 31 is a block diagram illustrating an SDC metadata generator in accordance with the present embodiment.

Referring to FIG. 31, a SDC metadata generator 106 generates SDC metadata 3100 having metadata information for a sensory device command.

FIG. 32 is a block diagram illustrating SDC elements of metadata in accordance with the present embodiment, in which SDC metadata 3100 includes metadata “SensoryDeviceCommand” 3200 describing a sensory device command.

FIG. 33 is a diagram illustrating SDC metadata described in a schema format in accordance with the present embodiment, in which the SDC metadata 3100 shown in FIG. 32 and elements of the SDC metadata 3100 are represented in a schema format.

Table 16 shows a description of SDC metadata 3100 in an XML schema format.

TABLE 16
<element name=“SDC”> <complexType> <sequence> <element
name=“SensoryDeviceCommand” type=“sei:SDCBaseType”
maxOccurs=“unbounded”/> </sequence> </complexType></element>

Table 17 shows a description provided as a basic type of the SDC metadata 3100, which is described in an XML schema format.

TABLE 17

<complexType name=“SDCBaseType” abstract=“true”>
<complexContent> <extension base=“sei:SEIBaseType”>
<anyAttribute namespace=“##other” process- Contents=“lax”/>
</extension> </complexContent></complexType>

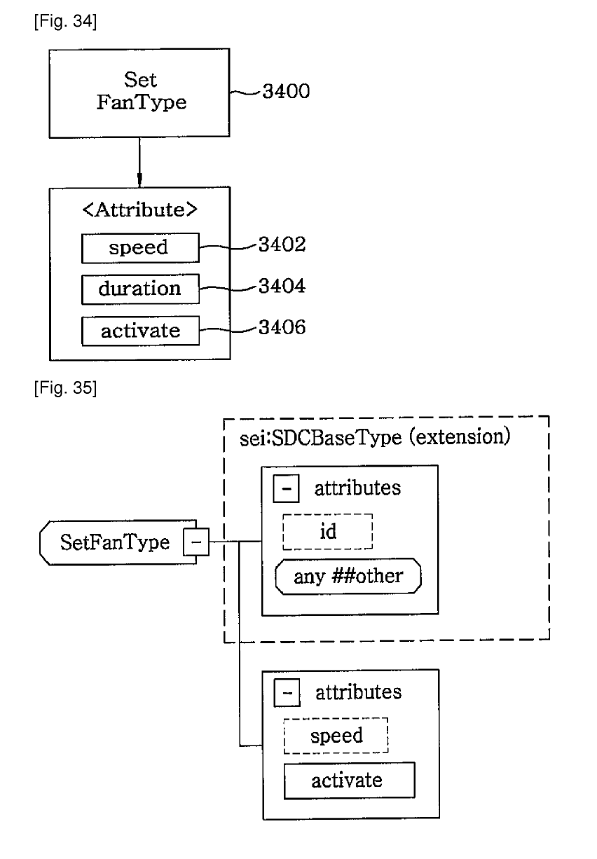

FIG. 34 illustrates an example of one sensory device command in accordance with the present invention, in which elements of metadata Set Fan Type 2400 describing device control command information for reproducing a wind effect are shown in block diagram.

Referring to FIG. 34, the elements include metadata “speed” 3402 describing attribute information indicating reproduction intensity, metadata “duration” 3404 describing attribute information indicating a constant reproducing time, and metadata “activate” 3406 describing attribute information indicating the sensory device activation.

FIG. 35 is a diagram illustrating metadata set Fan Type 3400 described in a schema format in accordance with the present embodiment, in which the metadata set Fan Type 3400 and elements of thereof are represented in a schema format.

Table 18 shows a description provided as a basic type of the metadata set Fan Type 3400, which is described in an XML schema format.

TABLE 18
<complexType name=“SetFanType”> <complexContent> <extension
base=“sei:SDCBaseType”> <attribute name=“speed”
type=“sei:percentType” use=“optional”/> <attribute
name=“activate” type=“sei:unsignedPatternType” use=“required”/>
</extension> </complexContent></complexType>

Further, in the present invention, various sensory device command information such as temperature, illuminant vibration effects and the like may be represented by using a method for generating metadata obtained by extending the description structure of the SDC metadata 3100, as the metadata set Fan Type 3400 that is one embodiment for representing the sensory device command.

That is, the metadata “SensoryDeviceCommand” 3200 describing sensory device command information may include unique identification information for a device to reproduce the sensory effect, sensory effect information for the sensory device, and metadata for parameter information related to the sensory effects.

For example, the metadata for type information of each sensory device may be extended as unique identification information for a device for reproducing the sensory effect. Metadata, such as original-color restoration setting information of video contents, illuminant reproduction setting information, vibration setting information, temperature reproduction setting information, and reproduction direction setting information of each sensory device may be included as each element of the type information metadata of each sensory device or sensory effect information for the sensory device and parameter information related to the sensory effects.

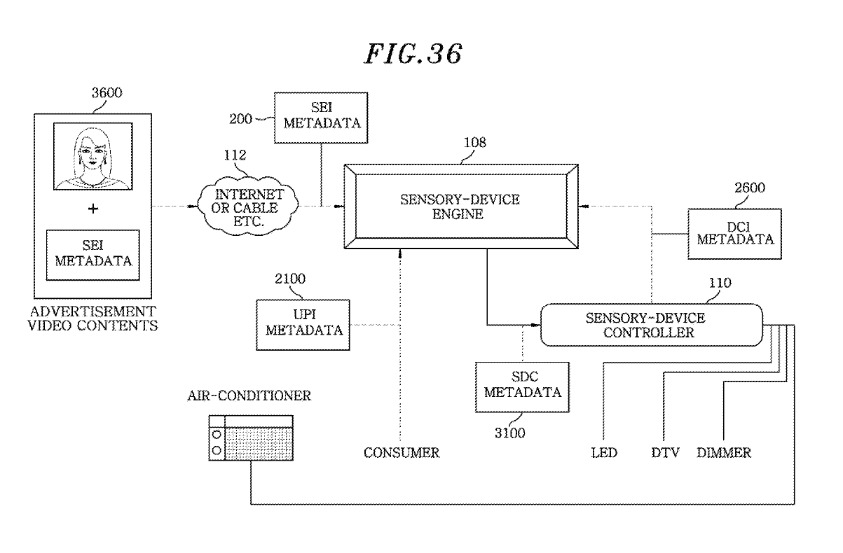

FIG. 36 illustrates multimedia application service of reproducing a sensory effect by using metadata in reproducing advertisement video contents in accordance with an embodiment of the present invention, in which an advertisement method using metadata for a multimedia application system and device that reproduce sensory effects in reproducing.

Referring to FIG. 36, advertisement video contents 3600 produced by an advertisement producer is provided to a user with sensory effects intended the producer. The producer produces SEI metadata 200 corresponding to original-color expression, main illuminant, ambient illuminant, and temperature to maximize the effect of the completed advertisement.

Table 19 shows an example of the SEI metadata 200 produced by an advertisement producer, which is described in an XML instance format.

TABLE 19
<?xml version=“1.0” encoding=“UTF-8”?><sei:SEI
xmlns:xsi=“http://www.w3.org/2001/XMLSchema-instance”
xmlns:sei=“urn:sei:ver1:present:RepresentationOfSensoryEffect:2008:07”
xmlns:mpeg7=“urn:mpeg:mpeg7:schema:2001”
xsi:schemaLocation=“urn:sei:ver1:present:RepresentationOfSensoryEffect:2008:07
sei.xsd urn:mpeg:mpeg21:2003:01-DIA-XSI-NS XSI-2nd.xsd”
xmlns=“urn:mpeg:mpegS:2008:01-sei-NS”
xmlns:si=“urn:mpeg:mpeg21:2003:01-DIA-XSI-NS” si:absTimeScheme=“mp7t”
si:timeScale=“50000”> <!-- Original Color Parameter Setting --> <sei:Parameters
xsi:type=“sei:ReferenceColorParameterType”> <sei:ToneReproductionCurves>
<sei:Record> <sei:DAC_Value>0</sei:DAC_Value> <sei:RGB_Value>0.0000
0.0000 0.0000</sei:RGB_Value> </sei:Record> <sei:Record>
<sei:DAC_Value>16</sei:DAC_Value> <sei:RGB_Value>0.0093 0.0087
0.0076</sei:RGB_Value> </sei:Record> <sei:Record>
<sei:DAC_Value>32</sei:DAC_Value> <sei:RGB_Value>0.0304 0.0312
0.0274</sei:RGB_Value> </sei:Record> <sei:Record>
<sei:DAC_Value>48</sei:DAC_Value> <sei:RGB_Value>0.0595 0.0633
0.0557</sei:RGB_Value> </sei:Record> <sei:Record>
<sei:DAC_Value>64</sei:DAC_Value> <sei:RGB_Value>0.0947 0.1026
0.0957</sei:RGB_Value> </sei:Record> <sei:Record>
<sei:DAC_Value>80</sei:DAC_Value> <sei:RGB_Value>0.1391 0.1486
0.1388</sei:RGB_Value> </sei:Record> <sei:Record>
<sei:DAC_Value>96</sei:DAC_Value> <sei:RGB_Value>0.1864 0.1974
0.1863</sei:RGB_Value> </sei:Record> <sei:Record>
<sei:DAC_Value>112</sei:DAC_Value> <sei:RGB_Value>0.2400 0.2555
0.2426</sei:RGB_Value> </sei:Record> <sei:Record>
<sei:DAC_Value>125</sei:DAC_Value> <sei:RGB_Value>0.2907 0.3082
0.2960</sei:RGB_Value> </sei:Record> <sei:Record>
<sei:DAC_Value>144</sei:DAC_Value> <sei:RGB_Value>0.3759 0.3951
0.3841</sei:RGB_Value> </sei:Record> <sei:Record>
<sei:DAC_Value>160</sei:DAC_Value> <sei:RGB_Value>0.4582 0.4778
0.4673</sei:RGB_Value> </sei:Record> <sei:Record>
<sei:DAC_Value>176</sei:DAC_Value> <sei:RGB_Value>0.5491 0.5666
0.5576</sei:RGB_Value> </sei:Record> <sei:Record>
<sei:DAC_Value>192</sei:DAC_Value> <sei:RGB_Value>0.6510 0.6653
0.6528</sei:RGB_Value> </sei:Record> <sei:Record>
<sei:DAC_Value>208</sei:DAC_Value> <sei:RGB_Value>0.7503 0.7644
0.7635</sei:RGB_Value> </sei:Record> <sei:Record>
<sei:DAC_Value>224</sei:DAC_Value> <sei:RGB_Value>0.8483 0.8644
0.8654</sei:RGB_Value> </sei:Record> <sei:Record>
<sei:DAC_Value>240</sei:DAC_Value> <sei:RGB_Value>0.9445 0.9546
0.9438</sei:RGB_Value> </sei:Record> <sei:Record>
<sei:DAC_Value>255</sei:DAC_Value> <sei:RGB_Value>1.0000 1.0000
1.0000</sei:RGB_Value> </sei:Record> </sei:ToneReproductionCurves>
<sei:ConversionMatrix> <sei:RGB_XYZ mpeg7:dim=“3 3”
xmlns:mpeg7=“urn:mpeg:mpeg7:schema:2001”> 86.6000 67.6000 38.0000 46.0000
137.0000 16.5000 2.3650 19.4100 203.9000 </sei:RGB_XYZ>
<sei:RGBScalar_Max>0.9910 0.9860 0.9820</sei:RGBScalar_Max>
<sei:Offset_Value>0.2150 0.2050 0.4250</sei:Offset_Value>
<sei:Gain_Offset_Gamma mpeg7:dim=“3 3”> 1.0228 −0.0228 1.6222 1.0242 −0.0242
1.5624 1.0220 −0.0220 1.6180 </sei:Gain_Offset_Gamma> <sei:Inversematrix
mpeg7:dim=“3 3”> 0.0155 −0.0073 −0.0023 −0.0052 0.0099 0.0002 0.0003 −0.0009
0.0049 </sei:Inversematrix> </sei:ConversionMatrix> <sei:Illuminant>
<sei:Daylight>D65</sei:Daylight> <sei:XY_Value x=“0.3127” y=“0.32907>
</sei:Illuminant> <sei:InputDeviceColorGamut> <sei:IDCG_Type
xmlns:mpeg7=“urn:mpeg:mpeg7:schema:2001”>NTSC</sei:IDCG_Type>
<sei:IDCG_Value mpeg7:dim=“2 3”> 0.6700 0.3300 0.2100 0.7100 0.1400 0.0800
</sei:IDCG_Value> </sei:InputDeviceColorGamut>
<sei:LuminanceOfSurround>180</sei:LuminanceOfSurround> </sei:Parameters>
<sei:SingleEffect xsi:type=“sei:ScreenType” activate=“1” resolution=“6” depth=“4”
si:pts=“0”/> <sei:SingleEffect xsi:type=“sei:ReferenceColorType” activate=“1”
si:pts=“0”/> <sei:SingleEffect xsi:type=“sei:LightType” activate=“1” luminance=“70”
lightNumber=“1” si:pts=“0”/> <sei:SingleEffect xsi:type=“sei:LightType”
activate=“1” method=“2” lightNumber=“9” vTime=“26.0” vDelta=“1.0” si:pts=“0”/>
<sei:SingleEffect xsi:type=“sei:FanType” activate=“1” duration=“26.0” speed=“20”
side=“3” si:pts=“0”/></sei:SEI>>

Table 19 shows an XML instance of the SEI metadata 200 including parameters for original-color restoration intended by an advertisement producer and describing main and ambient illuminant (LED) effects, a temperature effect, a wind effect and the like.

Advertisement medium in a multimedia application format (MAF) is generated to transmit completed advertisement video contents 3600 and corresponding SEI metadata 200. The MAF is used to express video contents and metadata in a media format in the present invention, but it is not limited thereto. The produced advertisement medium in an MAF format is delivered to the sensory-device engine 108 via the communication channel 112, such as the Internet or a cable, to inform the consumer (user) that there is a sensory effect for the advertisement video contents 300.

Accordingly, the advertisement consumer determines whether to apply the sensory effect of the transmitted advertisement medium. In an embodiment, the selection may be performed by using a graphic user interface (GUI) on a display for enabling the consumer to select a reproduction and a degree of reproduction effect. If the consumer desires to apply the advertisement medium reproduction effect, the UPI metadata 2100 is generated and transmitted to the sensory-device engine 108.

Table 20 shows UPI metadata 2100 generated by a consumer when the consumer applies the advertisement media effect, which is described in an XML instance format.

TABLE 20
<?xml version=“1.0” encoding=“UTF-8”?><UPI
xmlns=“urn:rose:ver1:present:RepresentationOfSensoryEffect:2008:07”
xmlns:dia=“urn:mpeg:mpeg21:2003:01-DIA-NS”
xmlns:mpeg7=“urn:mpeg:mpeg7:schema:2001”
xmlns:xsi=“http://www.w3.org/2001/XMLSchema-instance”
xsi:schemaLocation=“urn:rose:ver1:present:RepresentationOfSensoryEffect:2008:07
RoSE.xsd”> <PersonalInfo> <mpeg7:Name> <mpeg7:GivenName>Yong
Soo</mpeg7:GivenName> <mpeg7:FamilyName>Joo</mpeg7:FamilyName>
</mpeg7:Name> </PersonalInfo> <PreferenceDescription>
<SelectOriginalColor>true</SelectOriginalColor> <SelectDimming>
<Select>true</Select> <MaxLevel>100</MaxLevel> <MinLevel>0</MinLevel>
</SelectDimming> <SelectLED> <Select>true</Select>
<MaxLevel>100</MaxLevel> <MinLevel>0</MinLevel> </SelectLED>
<SelectTemperature> <Select>true</Select>
<MaxTemperature>45</MaxTemperature> <MinTemperature>0</MinTemperature>
</SelectTemperature> <SelectWind> <Select>true</Select>
<MaxLevel>100</MaxLevel> <MinLevel>0</MinLevel> </SelectWind>
</PreferenceDescription></UPI>

Table 20 shows an XML instance of the UPI metadata 2100 describing sensory effect preference information of an advertisement consumer, in which original-color reproduction, main illuminant, ambient illuminant, temperature, wind adjustment effects are all used, and degrees of a reproduction effect of main illuminant, temperature, and wind adjustment are described.

The sensory-device engine 108 is inputted with SEI metadata 200 for reproducing a sensory effect of advertisement medium, DCI metadata 2600 for ambient devices (a main illuminant, an ambient illuminant (LED), and an air conditioner) connected to the sensory-device controller 110, and UPI metadata 2100 that is sensory effect reproduction preference information of the consumer, and then, advertisement begins to be reproduced.

Table 21 shows DCI metadata 2600 of the sensory effect sensory device generated from the sensory-device controller 110, which is described in an XML instance format.

TABLE 21
<?xml version=“1.0” encoding=“UTF-8”?><DCI
xmlns=“urn:rose:ver1:present:RepresentationOfSensoryEffect:2008:07”
xmlns:dia=“urn:mpeg:mpeg21:2003:01-DIA-NS”
xmlns:mpeg7=“urn:mpeg:mpeg7:schema:2001”
xmlns:xsi=“http://www.w3.org/2001/XMLSchema-instance”
xsi:schemaLocation=“urn:rose:ver1:present:RepresentationOfSensoryEffect:2008:07
RoSE.xsd”> <DeviceCapability DeviceID=“light_1” TypeOfDevice=“Dimming”>
<Number>1</Number> <MinLevel>0</MinLevel> <MaxLevel>80</MaxLevel>
<Location>0</Location> </DeviceCapability> <DeviceCapability DeviceID=“led_1”
TypeOfDevice=“LED”> <Number>10</Number> <MinLevel>10</MinLevel>
<MaxLevel>70</MaxLevel> <Location>0</Location> </DeviceCapability>
<DeviceCapability DeviceID=“aircon_1” TypeOfDevice=“Temperature”>
<Number>1</Number> <MinLevel>5</MinLevel> <MaxLevel>55</MaxLevel>
<Location>2</Location> </DeviceCapability> <DeviceCapability DeviceID=“fan_1”
TypeOfDevice=“Fan”> <Number>2</Number> <MinLevel>25</MinLevel>
<MaxLevel>75</MaxLevel> <Location>2</Location> </DeviceCapability></DCI>

Table 21 shows an XML instance of DCI metadata 2600 describing ranges of sensory effect reproduction capabilities of sensory devices for respectively adjusting main illuminant and ambient illuminant, temperature, and wind.

While the advertisement is reproduced, the original-color expression, main illuminant, ambient illuminant, temperature and wind SEI metadata intended by the producer is interpreted by the sensory-device engine 108. In this case, the DCI metadata 2600 is interpreted to determine currently available sensory devices among the devices corresponding to sensory effects intended by the producer.

The user preference information is then finally interpreted based on the user UPI metadata 2100 and the generated SDC metadata 3100 is delivered to the sensory-device controller 110.

Table 22 shows an example of the SDC metadata 3100 generated by the sensory-device engine 108, which is described in an XML instance format.

TABLE 22
<?xml version=“1.0” encoding=“UTF-8”?><sei:SDC
xmlns:xsi=“http://www.w3.org/2001/XMLSchema-instance”
xmlns:sei=“urn:sei:ver1:present:RepresentationOfSensoryEffect:2008:07”
xmlns:mpeg7=“urn:mpeg:mpeg7:schema:2001”
xsi:schemaLocation=“urn:sei:ver1:present:RepresentationOfSensoryEffect:2008:07
sei.xsd urn:mpeg:mpeg21:2003:01-DIA-XSI-NS XSI-2nd.xsd”
xmlns=“urn:mpeg:mpegS:2008:01-sei-NS”
xmlns:si=“urn:mpeg:mpeg21:2003:01-DIA-XSI-NS” si:absTimeScheme=“mp7t”
si:timeScale=“50000”> <sei:SensoryDeviceCommand xsi:type=“sei:SetScreenType”
activate=“1” resolution=“6” depth=“4”/> <sei:SensoryDeviceCommand
xsi:type=“sei:SetReferenceColorType” activate=“1”/> <sei:SensoryDeviceCommand
xsi:type=“sei:SetLightType” activate=“1” luminance=“70” id=“light_1”/>
<sei:SensoryDeviceCommand xsi:type=“sei:SetLightType” activate=“1”
autoColor=“1” id=“led_1”/> <sei:SensoryDeviceCommand
xsi:type=“sei:SetFanType” activate=“1” id=“fan_1”/></sei:SDC>

Table 22 shows an XML instance of the SDC metadata 3100 transferred to the sensory-device controller 110, which describes original-color restoration information and reproduction effect degrees of main illuminant, ambient illuminant, temperature and wind adjustment according to the sensory effect reproduction information adjusted corresponding to the UPI metadata 2100 preferred by the consumer.

The sensory-device controller 110 reproduces, toward the consumer, the sensory effect intended by the producer by sending control signals to respective connected sensory devices based on the SDC metadata 3100. Accordingly, for instance, when a scene of cool sea with strong sunlight is being reproduced on an advertisement screen, original color impression intended by the advertisement producer is displayed with a strong main illuminant, a blue ambient LED (an ambient illuminant) illuminating as a cool sea background, and cool wind blowing from an air conditioner positioned back of the consumer. The consumer feels the urge to purchase advertised goods while reproducing the advertisement medium by the consumer.

If the consumer does not apply an advertisement medium effect, a beer advertisement reflecting color impression information of a digital television rather than an original color of a display intended by the advertisement producer is reproduced, and the consumer may not react to the advertisement.

Table 23 shows an example of UPI metadata 2100 generated from a consumer, which is described in an XML instance format, when the consumer does not apply an advertisement medium effect.

TABLE 23
<?xml version=“1.0” encoding=“UTF-8”?><UPI
xmlns=“urn:rose:ver1:present:RepresentationOfSensoryEffect:2008:07”
xmlns:dia=“urn:mpeg:mpeg21:2003:01-DIA-NS”
xmlns:mpeg7=“urn:mpeg:mpeg7:schema:2001”
xmlns:xsi=“http://www.w3.org/2001/XMLSchema-instance”
xsi:schemaLocation=“urn:rose:ver1:present:RepresentationOfSensoryEffect:2008:07
RoSE.xsd”> <PersonalInfo> <mpeg7:Name> <mpeg7:GivenName>Yong
Soo</mpeg7:GivenName> <mpeg7:FamilyName>Joo</mpeg7:FamilyName>
</mpeg7:Name> </PersonalInfo></UPI>

Table 23 shows an XML instance of UPI metadata 2100 describing sensory effect preference information of the consumer, which describes no use of original-color reproduction, main illuminant, ambient illuminant, temperature, wind adjustment effects.

As described above, the present invention is for effectively controlling ambient sensory devices, such as color impression of a display device and ambient illuminant according to video contents when the consumer watches in reproducing the video contents by using a new metadata format for optimally adjusting the color impression of the display device and the ambient sensory devices according to video contents. Therefore, provides consumer-oriented, high-quality multimedia service corresponding to an existing producer's intention can be provided.

While the invention has been shown and described with respect to the preferred embodiments, it will be understood by those skilled in the art that various changes and modifications may be made without departing from the scope of the invention as defined in the following claims.

1. A multimedia application system using metadata for sensory devices, the system comprising:
a sensory-device engine for generating a sensory device command (SDC) for controlling the sensory devices based on sensory effect information (SEI) generated to represent sensory effects by using the sensory devices depending on video contents, user preference information (UPI) of the sensory devices and device capability information (DCI) indicative of reproducing capability of the sensory devices; and
a sensory-device controller for controlling sensory devices to perform sensory effect reproduction in response to the generated SDC.

2. The system of claim 1, wherein the sensory-device engine generates the SDC based on the DCI after the UPI is reflected to the SEI.

3. The system of claim 2, wherein the sensory-device engine generates the SDC by setting sensory devices and control ranges for the sensory devices, based on the SEI, the UPI and the DCI,
wherein the SEI includes at least one of attribute information of the sensory devices, sensory effect information for the sensory devices, and parameter information related to the sensory effects,
wherein the UPI includes personal information of an end user and user preference information for the sensory effect,
wherein the DCI includes at least one of attribute information indicating unique identification number of the sensory devices, attribute information indicating a type of the devices, numbers of sensory devices, minimum device capability information, maximum device capability information, and position information of the devices, and
wherein the generated SDC includes at least one of unique identification information for sensory devices for reproducing sensory effects, sensory effect information for the sensory devices, and parameter information related to the sensory effects.

4. The system of claim 1, wherein the sensory-device controller generates the DCI including reproducing capability ranges of the sensory devices.

5. The system of claim 1, wherein the sensory-device controller transmits sensory effect reproduction commands to the sensory devices indicated in the SDC received from the sensory-device engine.

6. The system of claim 1, further comprising a communication channel for performing data transmission and reception between the sensory-device engine and the sensory-device controller.

7. The system of claim 6, wherein the data transmission and reception between the sensory-device engine and the sensory-device controller is made by wired and wireless communications.

8. The system of claim 1, wherein the sensory device comprises at least one of a display device, an illuminant device, a light emitting diode (LED) device, a temperature adjusting device, a wind adjusting device, and a scent adjusting device.

9. The system of claim 1, wherein the information of the SEI, UPI, DCI and SDC is formed in metadata of schema format.

10. The system of claim 1, wherein the information of the SEI, UPI, DCI and SDC is described in an extensible markup language (XML) instance or an XML schema.

11. A multimedia application method using metadata for sensory devices, the method comprising:
receiving, by a sensory-device engine, sensory effect information (SEI), the SEI being used for sensory devices to represent sensory effects according to video contents;
receiving user preference information (UPI) of the sensory devices;
receiving device capability information (DCI) indicative of reproducing capability of the sensory devices;
generating a sensory device command (SDC) to control the sensory devices based on the SEI, UPI and DCI; and
transmitting the SDC to a sensory-device controller interworking with sensory devices for performing sensory effect reproduction.

12. The method of claim 11, wherein said generating the SDC comprises:
reflecting the UPI to the SEI; and
generating the SDC by determining available sensory devices based on the DCI and the UPI-reflected SEI.

13. The method of claim 12, wherein the SDC is generated by setting sensory devices and control ranges for the sensory devices, based on the SEI, the UPI and the DCI,
wherein the SEI includes at least one of attribute information of the sensory devices, sensory effect information for the sensory devices, and parameter information related to the sensory effects,
wherein the UPI includes personal information of an end user and user preference information for the sensory effect,
wherein the DCI includes at least one of attribute information of unique identification number of the sensory devices, attribute information indicating a type of the devices, numbers of sensory devices, minimum device capability information, maximum device capability information, and position information for the devices, and
wherein the SDC includes at least one of unique identification information for devices for reproducing sensory effects, sensory effect information for the sensory devices, and parameter information related to the sensory effects.

14. The method of claim 11, wherein the DCI includes reproducing capability ranges of the sensory devices.

15. The method of claim 11, wherein said transmitting the SDC comprises transmitting, by the sensory-device controller, sensory effect reproduction commands to the sensory devices indicated in the SDC received from the sensory-device engine.

16. The method of claim 11, wherein data transmission and reception between the sensory-device engine and the sensory-device controller is performed through a interworking communication channel.

17. The method of claim 16, wherein the data transmission and reception between the sensory-device engine and the sensory-device controller is made by wired and wireless communications.

18. The method of claim 11, wherein the sensory device comprises at least one of a display device, an illuminant device, a light emitting diode (LED) device, a temperature adjusting device, a wind adjusting device, and a scent adjusting device.

19. The method of claim 11, wherein the information is formed in metadata of schema format.

20. The system of claim 11, wherein the information is described in an extensible markup language (XML) instance or an XML schema format.
